(19) United States
(12) Patent Application Publication
(10) Pub. No.: US 2010/0019201 A1
(43) Pub. Date: Jan. 28, 2010

(54) HYDROTHERMAL PROCESS FOR PRODUCING NANOSIZE TO MICROSIZE PARTICLES

(75) Inventors: Lothar Puppe, Burscheid (DE); Johan Kijlstra, Odenthal (DE); Ralph Weber, Leichlingen (DE); Michaela Frye, Langenfeld (DE); Dirk Storch, Koln (DE)

Correspondence Address: CONNOLLY BOVE LODGE & HUTZ, LLP, P O BOX 2207, WILMINGTON, DE, 19899, US

(73) Assignee: H. C. Starck GmbH, Goslar (DE)

(21) Appl. No.: 11/777,313

(22) Filed: Jul. 13, 2007

(30) Foreign Application Priority Data
Jul. 13, 2006 (DE) 10 2006 032 590.7

(51) Int. Cl. C01F 17/00; C09K 11/78; C07F 5/00; C01G 53/04; C01G 5/00

(52) U.S. Cl. 252/301.4 R; 423/263; 534/16; 423/594.19; 423/604

(57) ABSTRACT

The present invention relates to a process for producing nanosize to microsize particles of compounds of the rare earth metals and other transition metals and also for producing colloid-chemically stable sols of these particles.

The present invention relates to a process for producing nanosize to microsize particles of compounds of the rare earth metals and other transition metals and also for producing colloid-chemically stable sols of these particles.

The precipitation and coprecipitation of metal ions from the aqueous phase are processes which have been known for a long time for the synthesis and production of inorganic and microsize particles for, for example, pigments, catalysts and ceramic materials. In industrial production, these processes are used mainly for producing (sub)microsize particles, i.e. particles having particle sizes of greater than 100 nm. Important product criteria are, inter alia, the morphology, the mean particle size, the particle size distribution and the processing properties of the particles.

Depending on the materials system, it is also possible to produce nanosize particles, i.e. particles having particle sizes of <100 nm, by means of precipitation processes. However, the wet-chemical production of nanosize particles is more difficult than that of microsize particles, so that it has hitherto been possible to produce only a limited number of nanosize particles wet-chemically by means of precipitation processes in industry (e.g. SiO₂, TiO₂ and Fe₂O₃). In general, these processes provide only limited opportunities of varying the particle size (cf. in the case of SiO₂ particles DE-A 4218306).

A distinction is made between heterogeneous and homogeneous precipitation processes. In a heterogeneous precipitation process, the mixture of two starting materials leads to immediate particle formation. In a homogeneous precipitation reaction, the particles are formed in a homogeneous solution. In this case, particle formation can be induced, for example, by:
decomposition of dissolved metal complexes,
forced hydrolysis of dissolved metal ions complexed by water molecules or
controlled homogeneous liberation of precipitation reagents by decomposition of organic molecules, if appropriate with heating.

A known heterogeneous precipitation process for producing microsize particles of rare earth metal compounds is precipitation from the corresponding metal salt solutions by means of ammonia-containing solutions (M. D. Rasmussen, M. Akinc, O. Hunter, Ceramics International 1985, 11, 2, 51-55). Such basic solutions as precipitation reagent generally form a hydroxide which can be converted into an oxide by calcination.

A known process for producing microsize particles of metal compounds is homogeneous precipitation from metal salt solutions at elevated temperature. The elevated temperature leads to forced hydrolysis of the dissolved metal ions and thus to particle formation. Matijevic (Langmuir, 1986, 2, 12-20; Acc. Chem. Res. 1981, 14, 22-29; Ann. Rev. Mater. Sci.; 1985; 15, 483-516) describes how this process can be used in batch operation for the production of microsize oxidic and hydroxidic particles.

A known process for producing microsize metal (hydr)oxide particles is based on the thermal decomposition of soluble metal chelates in sodium hydroxide solution under hydrothermal conditions. Sapieszko (journal of Colloid Interface Science, 1980, 74, 2, 405-422) and Matijevic (Acc. Chem. Res. 1981, 14, 22-29; Langmuir 1986, 2, 12-20) describe how this process can be used in batch operation for the production of microsize particles of many metal (hydr) oxides.

Suitability of these two latter processes for the production of particles of rare earth metals has not been described hitherto.

A further known batch process for producing monodisperse microsize particles is homogeneous precipitation of metal compounds in urea-containing metal salt solutions. Heating of the aqueous solution leads to thermally induced hydrolysis of the urea and thus to homogeneous liberation of precipitation reagents (ammonia and CO₂) which lead to formation of basic, carbonate-containing compounds of the metal. These compounds can be converted into the corresponding oxides by calcination. The application of this process to the production of microsize and submicrosize particles of rare earth metals has been described by Akinc and Sordelet (Advanced Ceramic Materials, 1987, 2 (3A) 232-38E), Matijevic and Hsu (Journal of Colloid and Interface Science 1987, 118, 2, 506-523) and Sordelet and Akinc (journal of Colloid and Interface Science 1988, 122, 1, 47-59). The methods operate at a low starting material concentration, generally below 50 mM, since the particles tend to agglomerate at higher concentrations.

According to Sohn et al. (Powder Technology 2004, 142, 136-153), a further reduction in the starting material concentration also makes it possible to obtain nanosize particles of yttrium compounds, but no smaller than 50 nm. Addition of complexing agents such as EDTA makes it possible to achieve a similar reduction in the particle size (M. Kobayashi, Journal of Materials Science Letters, 1992, 11, 767-768).

EP-A 842 899 and US-A 2002/0017635 describe homogeneous precipitation processes (batch operation) using urea as precipitation reagent for producing spherical particles of rare earth metals having a particle size in the range from 0.2 to 2.0 μm.

The batch synthesis of inorganic particles by the homogeneous precipitation process using urea as precipitation reagent has various disadvantages:
submicrosize and nanosize particles can only be obtained at very low starting material/product concentrations, with the solids content being significantly below 5 g/l
nanosize particles having particle sizes of less than 50 nm cannot be obtained
at higher starting material concentrations, particle agglomeration occurs.

Only at a high, about 20-fold excess of urea does the yield approach 100% (see, for example, Sordelet and Akinc, Journal of Colloid and Interface Science 1988, 122, 1, 47-59).

U.S. Pat. No. 6,596,194 describes the batch synthesis of nanosize (<10 nm) oxidic particles of rare earth metals (including particles of phosphors) in solvents by means of dissolved surface-active substances which can preferably form complexes with metal ions. EP-A 0 684 072 describes a batch process for producing nanosize particles (<10 nm) of rare earth metals and combinations of these with other metals in aqueous media. The process comprises precipitation of dissolved metal cations from a solution having a concentration of more than 0.1 mol/l by addition of an ammonia-containing solution, separation and drying of the solid with subsequent redispersion in demineralized water. WO-A 01/38225 describes a batch process for producing nanosize particles of rare earth metals in aqueous media by means of complexing agents, e.g. citrate. The process comprises precipitation of the dissolved metal cations (concentration >0.1 M) by addition of ammonia-containing solutions at room temperature with subsequent hydrothermal treatment. The size of the resulting particles is in the range from 2 to 5 nm.

However, according to EP-A 0 684 072 and WO-A 01/382225, variation and matching of the particle size cannot be achieved by means of process modification. The production of nanosize particles having a particle size above 10 nm is not described.

U.S. Pat. No. 6,719,821 and US-A 2004139821 describe the batch production of nanosize powders of the rare earth metals by means of wet-chemical precipitation using ammonia as precipitation reagent. The XRD crystallite size of the calcined samples is less than 20 nm. No information is given about the size of the primary particles or about the redispersibility after calcination.

All the abovementioned processes are, inter alia, batch processes. However, the discontinuous mode of operation of these batch processes is disadvantageous for industrial use, in particular in respect of efficiency.

U.S. Pat. No. 5,652,192 and WO-A 94/01361 describe a hydrothermal process for the continuous and homogeneous precipitation of nanosize particles. Examples of this continuous hydrothermal process are also described by Matson et al. (Particulate Science and Technology, 1992, 10, 143-154) and Darab et al. (Journal of Electronic Materials, 1998, 27, 10). To produce particles, an aqueous metal salt solution which if possible comprises further thermally reactive components is pumped in succession through various functional units, i.e. a heated capillary reactor and a cooled capillary (or heat exchanger). Downstream of the cooled capillary, the nanoparticle-containing dispersion flows through a pressure valve and an outlet capillary into a collection vessel. The residence and reaction times are determined by setting of the preferably constant volume flow and the dimensions of the functional units (diameter, length). The capillary dimensions are selected so that the temperature of the flowing liquid quickly becomes the same as the temperature of the functional unit. The targeted setting of residence and reaction times, temperature and pressure is said to make continuous production of particles having a controllable particle size distribution possible. Nanoparticles can be obtained under hydrothermal reaction conditions at short reaction times of typically less than 60 s. U.S. Pat. No. 5,652,192 and WO-A 94/01361 describe the use of dissolved substances such as urea which decompose on heating and homogeneously liberate precipitation reagents. However, this continuous, hydrothermal urea process is not suitable for the economical production of colloid-chemically stable dispersions of nanosize particles, in particular their industrial production, since it has significant disadvantages such as
the low yield of the reaction (<50%)
the low period of operation of the process (in the range of minutes) because of blockage of capillaries and
the unsatisfactory colloidal stability of the product dispersion.

A further disadvantage is the low pH of the product sol obtained, which is below pH=6. Such an acidic pH is unfavourable for the further processing of particular products, e.g. those of rare earth metal compounds. The rare earth particles produced redissolve relatively quickly under these conditions, which would therefore make rapid work-up of these products necessary.

There is therefore a continuing need for a process for the wet-chemical production of nanosize to microsize particles of compounds of the rare earth metals and other transition metals and also for the production of colloid-chemically stable sols of these particles which does not have the abovementioned disadvantages.

It was therefore an object of the present invention to provide a process, in particular a continuous process, for producing nanosize to microsize particles of the compounds of the rare earth metals and other transition metals which makes a longer period of operation possible and gives the products in relatively high yield.

This process should preferably make it possible to produce nanosize particles having particle sizes of less than 20 nm. The particles obtained should preferably be readily dispersible in liguid media in order to make it possible to produce colloidally stable sols. The process of the invention very particularly preferably makes it possible to produce slightly alkaline sols having a pH of from 7 to 10. Furthermore, the process of the invention preferably allows problem-free scale-up from a laboratory scale to a production scale. The production of such particles having a narrow particle size distribution and/or the possibility of varying the particle sizes by modification of the process conditions would be advantageous.

The object of the invention has surprisingly been achieved by means of a process in which nanoparticles or microparticles of rare earth metal compounds or other transition metal compounds are precipitated in the presence of a weakly basic precipitant under hydrothermal conditions.

The present invention accordingly provides a process for producing microparticles or nanoparticles of rare earth metal compounds or other transition metal compounds by homogeneous precipitation of these particles from a metal salt solution of at least one of the corresponding rare earth metals or transition metals by means of one or more precipitation reagents, characterized in that:
one or more weakly basic compound(s) which are soluble in a solvent or solvent mixture and are stable at the process temperature are used as precipitation reagent,
and the precipitation is carried out under hydrothermal conditions.

The process of the invention preferably comprises the following process steps:
metal salts and precipitation reagents are firstly mixed with one another in the solvent or solvent mixture to produce a homogeneous precipitation mixture (mixing phase)
the temperature of the precipitation mixture is subsequently increased (precipitation phase) and
after the precipitation is complete, the micro-particles or nanoparticles obtained are discharged, if appropriate after cooling.

For the purposes of the present invention, hydrothermal conditions are temperatures of 80° C. and above and pressures above atmospheric pressure (greater than 1 atm). For the purposes of the invention, hydrothermal conditions are preferably temperatures in the range from 80 to 500° C. particularly preferably from 90 to 300° C., very particularly preferably from 100 to 250° C., and pressures above atmospheric pressure. The increase in temperature of the homogeneous precipitation mixture in the precipitation phase under increased pressure induces and/or accelerates the precipitation of the particles.

For the purposes of the invention, homogeneous precipitation is precipitation from a solution or dispersion which has virtually no concentration gradients of the precipitant. This can be achieved, for example, by stirring or other homogeneous mixing of the precipitant with the metal salt solution and any further components prior to precipitation.

When the materials system, i.e. the metal salt solution and precipitant and their concentrations, and the process parameters (e.g. process temperature, process pressure, duration of the mixing phase and duration of the precipitation phase) are selected appropriately, the process of the invention enables microparticles or nanoparticles having a spherical or nonspherical particle morphology (e.g. platelets and rods) to be produced, i.e. particle size and particle morphology can be modified. For the purposes of the invention, submicroparticles are also encompassed by the term microparticles. Preference is given to producing nanoparticles and submicroparticles by means of the process of the invention. The process of the invention is particularly preferably used to produce nanoparticles.

For the purposes of the invention, nanoparticles are defined as particles which are smaller than 100 nm in at least one spatial dimension. For the purposes of the invention, microparticles are defined as particles which are larger than 1 μm in all three dimensions. For the purposes of the invention, submicroparticles are defined as particles which are larger than 100 nm in all three dimensions and are smaller than 1 μm in at least one dimension. The particle sizes are determined either by means of ultracentrifuge measurement, in which case the size measured is the volume average diameter and the abovementioned numerical values correspond to the D₅₀, i.e. 50% by weight of all particles have a diameter below the indicated size, or by means of transmission electron microscopy, in which case the diameter is the number average diameter and the numerical values indicated represent the particle sizes actually measured with the aid of the micrographs or minimum or maximum particle sizes actually measured. Measurement by means of electron microscopy is preferred.

The duration of the mixing phase is preferably set so that the formation of metal salt nuclei before commencement of the precipitation phase is minimized.

For the purposes of the invention, particles of rare earth metal compounds or other transition metal compounds are, in particular, particles of rare earth metal or other transition metal oxides, hydroxides, basic carbonates (i.e. hydroxycarbonates) and basic carboxylates (e.g. hydroxyacetates, hydroxyoxalates and hydroxycitrates), with the basic carbonates and basic carboxylates likewise being able to be subsequently converted into the corresponding hydroxides or oxides. The basic carbonates and basic carboxylates will therefore hereinafter also be referred to as precursors of such hydroxides or oxides. The process of the invention is preferably used to produce the oxides or hydroxides as rare earth metal compounds or other transition metal compounds either directly or indirectly, i.e. via subsequent decomposition of the precursors. Here, such compounds of one or more metals selected from the group consisting of the rare earth metals or other transition metals can be obtained. In the case of a plurality of such metals, it is also possible for a metal to be present only as dopant, i.e. present in significantly smaller amounts than the amount of the other metal.

When nanosize precursors of oxidic particles are obtained, the isolated nanoparticles can, for example, be converted into the oxidic phase by calcination. A further possibility is to carry out this conversion in an organic solvent at elevated temperature (if necessary under solvothermal conditions) with retention of the nanosize morphology. This requires firstly a phase transfer of the nanosize precursor from the aqueous phase into an organic phase, e.g. by distillation of water from the precipitant-containing product dispersion.

For the purposes of the present invention, rare earth metals are preferably the elements scandium, yttrium and lanthanum from Group 3 and all lanthanides having atomic numbers from 53 to 71, i.e. Ce, Pr, Nd, Pm, Sm, Eu, Gd, Tb, Dy, Ho, Er, Tm, Yb, Lu. Other transition metals are, for the purposes of the invention, preferably the metals of Groups 4, 5, 6, 7, 8, 9, 10, 11, 12 and 14 of the long Periodic Table in accordance with the IUPAC (3 Oct. 2005). Preferred other transition metals are Ni, Ag, Nb, Ta, particularly preferably Nb and Ta.

For the purposes of the invention, metal salt solutions of these metals are preferably solutions of corresponding metal salts having monovalent anions. Mention may here be made by way of example of solutions of the corresponding halides, preferably the chlorides, carboxylic acid salts, preferably acetates, oxalates or citrates, or nitrates.

The precipitation can be carried out from one or more starting solutions. If only one starting solution is used, the metal salt and the precipitation reagent are mixed homogeneously in the solvent or solvent mixture to give a precipitation mixture. The precipitation mixture preferably comprises at least two mixed starting solutions, with one of the starting solutions being a metal salt solution and a further starting solution containing one or more precipitation reagents. Metal salt solution and precipitation reagent solution are in this case combined with one another either simultaneously or in succession, preferably simultaneously, and homogeneously mixed.

The starting solutions or the precipitation mixture are homogeneously mixed by, for example, intensive stirring or other methods known to those skilled in the art.

Suitable solvents are aqueous or organic solvents, preferably polar solvents such as water, primary, secondary and tertiary alcohols, e.g. methanol, ethanol, 2-propanol, propanediols, butanol, trimethylolpropanes, diacetone alcohol, monoethylene glycol, diethylene glycol, triethylene glycol, polyethylene glycols, 1-methoxy-2-propanol, 2-amino-2-methyl-1-propanol, glycerol, ketones or aldehydes, e.g. acetone, acetylacetone, acetaldehyde, ethers such as tetrahydrofuran, amides such as dimethylformamide, sulphoxides such as dimethyl sulphoxide, amines such as ethanolamine, diethanolamine, dimethylethanolamine and triethanolamine or mixtures containing one or more of these solvents. Particularly preferred solvents are water or water-containing solvent mixtures. If appropriate, precipitant and solvent can be identical.

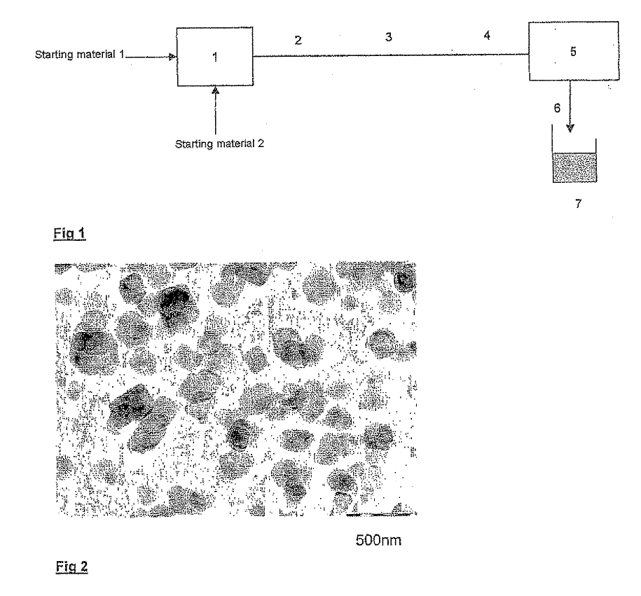

The concentration of the metal salt solution is advantageously in the range from 0.001 to 2.0 mol/l, preferably from 0.01 to 1.0 mol/l and in particular from 0.1 to 0.5 mol/l. Such a metal salt solution is, for example, the starting solution 1 as shown in FIG. 1 (starting material 1).

The concentration of the metal salt in the precipitation mixture is advantageously from 0.0005 to 1.0 mol/l, preferably from 0.005 to 0.5 mol/l and in particular from 0.05 to 0.25 mol/l.

As precipitation reagents, it is possible to use one or more weakly basic compounds which are soluble in the solvent or solvent mixture used, preferably soluble in water, and stable at the process temperature in the process of the invention. Weakly basic compounds whose use results in minimal or at least insignificant formation of metal salt nuclei in the starting mixture or the homogeneous precipitation mixture during the mixing phase are particularly suitable.

For the purposes of the invention, weakly basic compounds are compounds having a pK_{B} of from 3.0 to 11.0, preferably from 4.0 to 7.0.

As weakly basic precipitation reagents, preference is given to using primary, secondary or tertiary amines and amino alcohols. Particular preference is given to ammonia, triethanolamine, diethylenetriamine, ethylene-diamine, trimethylenediamine, triethylenetetramine, trimethylamine, triethylamine, tert-butylamine, n-butylamine, di-n-propylamine, tri-n-propylamine, triisopropanolamine, 2-aminoethanol, aniline, benzylamine, tris(hydroxymethyl)aminomethane, 2-amino-2-methyl-1-propanol, ethyldiisopropylamine, dimethyl-cyclohexylamine, 2-(methylamino)ethanol, 2-(dimethyl-amino) ethanol, diisopropylamine, hydroxylamine, 2-amino-2-(hydroxymethyl)-1,3-propanediol (tris), very particularly preferably ethanolamine, diethanolamine and triethanolamine.

It has surprisingly been found that weakly basic substances which at room temperature do not lead to precipitation of compounds of dissolved metal ions, or lead to only slow precipitation of such compounds, under hydrothermal conditions, in particular at elevated temperature, can be used successfully as homogeneous precipitation reagents. The precipitation reaction according to the invention differs from the known hydrothermal batch processes using amines in that the simultaneous use of strong bases such as potassium hydroxide solutions is described in the prior art. The hydrothermal precipitation reaction according to the invention differs from the known hydrothermal, continuous processes (U.S. Pat. No. 5,652,192 A and WO 94/01361 A) inter alia, in that no substances which decompose on heating and thus homogeneously liberate precipitation reagents are used. This prevents the by-products formed in this thermal decomposition from contributing, for example, to blockage of the reactors. In addition, the weakly basic precipitation reagents used according to the invention can additionally stabilize the particles obtained and prevent uncontrolled agglomeration, for example in sols produced therefrom.

The concentration of the precipitation reagent solution is advantageously from 0.01 to 10 mol/l, preferably from 0.1 to 10.0 mol/l and in particular from 0.1 to 5.0 mol/l. Such a precipitation reagent solution is, for example, the starting solution 2 as shown in FIG. 1 (starting material 2).

The concentration of the precipitation reagent in the precipitation mixture is advantageously from 0.005 to 5 mol/l, preferably from 0.05 to 5.0 mol/l and in particular from 0.05 to 2.5 mol/l.

Preference is given to using storage-stable starting solutions. Chemically or physically unstable liquid starting solutions such as premixed starting solutions containing metal salt and precipitant can optionally be used. If appropriate, the residence time between making up the starting solutions and carrying out the process can be monitored and/or specifically set.

If appropriate, soluble substances such as low molecular weight additives, salts, surfactants, polymers, dispersants and complexing agents can be added to the starting solutions.

Addition of such additives and/or water-soluble solvents enables targeted coagulation of the nano-particles to be induced so as to simplify solid-liquid separation considerably. When suitable coagulation conditions are chosen, the coagulation is reversible so that the agglomerated particles can be redispersed by uptake in water or solvent, possibly with input of energy.

The starting solution or the precipitation mixture composed of a plurality of starting solutions is preferably a single-phase and liquid system under process conditions.

The process of the invention can be operated either batchwise or continuously. In this case, preference is given to carrying out the process continuously.

Furthermore, the corresponding sols of the nanoparticles or microparticles of rare earth metal compounds or other transition metal compounds can be produced by means of the process of the invention.

For the purposes of the invention, a sol is a dispersion of nanoparticles or microparticles, preferably nanoparticles, or submicroparticles, in a liquid. These can preferably be highly concentrated, transparent sols. Possible liquids for the purposes of the invention are the abovementioned solvents or solvent mixtures. Depending on the amount of solvent, it is also possible to obtain pastes or non-Newtonian liquids containing nanoparticles or microparticles, preferably nanoparticles or submicroparticles, by the process of the invention. Very particular preference is given to sols containing nanoparticles.

The sol can, according to the invention, be obtained directly by discharge of the particles in an appropriate solvent or solvent mixture or be produced by subsequent redispersion of the particles obtained in an appropriate solvent or solvent mixture.

The colloid-chemical stability of the particles in the sols can, if appropriate, also be optimized by means of a washing step or by addition of additives.

The process of the invention can also be employed for coating inorganic microparticles or nanoparticles with compounds of rare earth metals or other transition metals.

The present invention therefore further provides a process according to the above-described process of the invention for producing inorganic microparticles or nanoparticles coated with rare earth metal compounds or other transition metal compounds by homogeneous precipitation from a metal salt solution of at least one of the corresponding rare earth metals or transition metals by means of one or more precipitation reagent(s), characterized in that coating is effected from a homogenized precipitation mixture which comprises two or more starting solutions, with one of the starting solutions being a metal salt solution and the second starting solution containing inorganic microparticles or nanoparticles, and to which the precipitant is added either together with one of the two starting solutions or with a further starting solution.

As possible inorganic nanoparticles or microparticles, preferably nanoparticles, use is made of inorganic oxides or hydroxides. These are, for example, SiO₂, Al₂O₃, TiO₂, ZrO₂ or rare earth oxides, preferably having a known, defined particle size distribution.

The process parameters, information on precipitant, metal compounds, solvent, concentrations, etc., indicated above and likewise their preferred ranges apply to the coating process.

In the continuous production of microparticles and nanoparticles by wet-chemical and homogeneous precipitation processes according to the above-described process of the invention, the use of mixing units, in the present case particularly for producing the homogeneous precipitation mixture, is necessary. As mixing unit, it is possible to use, inter alia, micro-reactors and dispersing nozzles or jet reactors.

The term “microreactor” employed refers to miniaturized, preferably continuously operating reactors which are known under the names microreactor, minireactor, micromixer or minimixer. Examples are T- and Y-mixers and also the micromixers from various companies (e.g. Ehrfeld Mikrotechnik ETS GmbH, Institut fur Mikrotechnik Mainz GmbH, Siemens AG, CPC-Cellulare Process Chemistry Systems GmbH). Examples of jet reactors are the MicroJetReactor (Synthesechemie GmbH) and the jet disperser (Bayer Technology Services GmbH).

The process of the invention is preferably carried out as a microprocess in a capillary system comprising one or more micromixers (1), residence zone (2), reactor (3), cooler (4) and pressure valve (5). In this case, the starting solutions are particularly preferably pumped through the plant or through the capillary system at a constant flow rate by means of high-pressure pumps, e.g. HPLC pumps. The liquid is depressurized via the pressure valve (5) downstream of the cooler and is collected via an outlet capillary (6) in a product container (7) (FIG. 1).

To carry out the process continuously, some process engineering parameters such as the dimensions of the capillaries (length, diameter) and choice of the mixer are fixed while others such as temperature, volume flow rates and pressure can be set in a targeted manner while carrying out the process of the invention. The mean residence times in the plant are thus also controlled.

The mixer is preferably a micromixer having a mixing time of less than 10 s, preferably less than 5 s and in particular less than 0.5 s.

Capillaries or capillary systems are usually employed as residence zone, reactor and cooler.

The effective capillary diameter of the residence zone, of the reactor and of the cooler is usually from 0.05 mm to 20 mm, preferably from 0.1 mm to 10 mm and in particular from 0.5 to 5 mm.

The length of the residence zone, of the capillary reactor and of the cooler is usually from 0.05 to 10 m, preferably from 0.05 to 5 m and in particular from 0.1 to 0.5 m.

The temperature of the residence zone is advantageously from 0° C. to 100° C., preferably from 0° C. to 50° C. and in particular from 0° C. to 30° C.

The temperature of the cooler is advantageously from 0° C. to 50° C., preferably from 0° C. to 20° C. and in particular from 0° C. to 10° C.

The temperature of the capillary reactor is advantageously from 50° C. to 500° C., preferably from 80° C. to 500° C., very particularly preferably from 90° C. to 300° C. and in particular from 100° C. to 250° C.

The flow rates of the feed streams are advantageously from 0.05 ml/min to 5 l/min, preferably from 0.05 ml/min to 250 ml/min and in particular from 1.0 to 100 ml/min.

The starting solutions are preferably pumped through the plant or through the capillary system at a constant flow rate and specifically set pressure by means of high-pressure pumps.

The pressure in the capillary system is advantageously from 1 to 500 bar, particularly preferably from 50 bar to 300 bar and in particular from 75 bar to 200 bar. The pressure is preferably set so that, depending on the reaction temperature, a single-phase and liquid system is present in the capillary reactor under process conditions.

The hydrothermal process of the invention differs from the known hydrothermal continuous processes according to U.S. Pat. No. 5,652,192 and WO-A 94/01361, inter alia, in that according to the process of the invention two process engineering steps, i.e.
mixing of the starting materials in the micromixer (1) and
residence of the starting mixture in the residence zone (2),
   are additionally carried out. These additional steps prevent uncontrolled formation of nuclei before the precipitation. Both process engineering steps are therefore carried out under controlled, in particular thermostatic, conditions, i.e. in particular at a defined temperature. The dimensions of the residence zone determines, at a given flow rate, the mean residence time of the starting mixture in the residence zone. The size of the particles can be controlled by setting the residence time.

To produce nanoparticles, the starting solutions are usually mixed immediately upstream of the heated capillary reactor, i.e. the residence time in the residence zone (2) is set to such a value that the mixing and thus the homogeneity of the precipitation mixture is optimized and at the same time the formation of metal salt nuclei is minimized.

In continuous operation, the mean residence time of the liquid in the capillary reactor is not more than 5 minutes, preferably less than one minute, particularly preferably from 0.1 s to 5 s.

Compared to the known continuous hydrothermal processes, the process of the invention is distinguished, inter alia, by
a surprisingly high reaction yield of usually above 60%, preferably above 70%, compared to about 40% and less according to the prior art and
stable operation with a surprisingly long period of operation, usually by a factor of at least 10, preferably by a factor of at least 20.

In addition and in contrast to the known continuous hydrothermal processes, colloidally and chemically stable sols of nanosize and (sub)microsize particles of differing morphologies, e.g. spheres, rods and platelets, can surprisingly be produced as a function of the materials system and process conditions.

The sols which can be obtained by the process are slightly alkaline and preferably have a pH of from 7 to 12, particularly preferably a pH of from 7 to 10.

To remove accompanying substances and/or salts dissolved in the product dispersion and to concentrate the dispersion, it is possible to use customary processes of mechanical liquid removal (e.g. filtration on a pressure filter or in a centrifugal field or sedimentation in the gravitational field or a centrifugal field), of extraction, of membrane technology (dialysis) and of distillation.

To characterize the particles, the particle size, the particle size distribution and the particle morphology are determined, for example, by means of transmission electron microscopy (TEM, Philips CM 20) and the particle size and particle size distribution also, for example, by means of ultracentrifugation (UC). The method of ultracentrifugation has been described by H. G. Müller (Colloid and Polymer Science 267, 1113-1116, 1989; Progress in Colloid and Polymer Science 107, 180-188, 1997). A suitable method of characterizing the crystallinity of the particles is, for example, X-ray diffractometry (reflection diffractometer DS000, Bruker AXS).

The yield of the reaction is, for example, determined gravimetrically, if necessary after calcination of the isolated particles at 800° C.

To characterize the chemical composition of the particles, the particles are examined thermo-gravimetrically using a coupled thermogravimetry/mass spectroscopy unit (TG-MS). For this purpose, the particles are isolated by centrifugation and firstly predried at a defined temperature in a stream of inert gas (helium, 50 ml per minute) for a defined time in the TG-MS unit. The sample is then maintained at 100° C. for 1 hour and then heated using a ramp of 5 K per minute to 800° C. During the entire measurement procedure, mass spectra in the mass range 1-200 amu are recorded.

The process of the invention can be used for producing inorganic, nanosize and microsize, preferably nanosize and submicrosize, particularly preferably nanosize, particles and their sols and formulations, e.g. for pigments, catalysts, coating materials, thin functional layers, materials for electronics, electroceramics, polishing compositions, materials and coatings having optical, e.g. highly refractive, properties, Stokes and anti-Stokes phosphors, biolabels, inks, semiconductors, superconductors, materials for anti-forgery methods, polymer composites, antimicrobial materials and formulations of active compounds.

Particularly the nanoparticles or microparticles of niobium or tantalum compounds which can be obtained by the process of the invention and also their sols have hitherto not been described in the prior art.

The present invention therefore further provides nanoparticles or microparticles containing niobium or tantalum compounds, in particular niobium oxides or tantalum oxides, which can be obtained by the process of the invention and also their sols. Preference is given to nanoparticles or microparticles of this type comprising niobium or tantalum compounds, in particular niobium oxides or tantalum oxides, and also their sols.

These are particularly preferably suitable as dopants for ceramic multilayer condensers and for use in catalysts for selective oxidation.

FIG. 1: Schematic depiction of the process

FIG. 1 shows a schematic diagram of the apparatus for carrying out the process, without the invention being restricted thereto.

### REFERENCE NUMERALS

1—mixer
2—residence zone
3—heated capillary reactor
4—cooler
5—pressure valve
6—outlet capillary
7—product container

FIG. 2: Electron micrograph (TEM) of the nanoparticles from Example 2

The following examples illustrate the present invention but do not restrict its scope.

### EXAMPLES

### Example 1

Yttrium-containing nanoparticles were produced continuously by the process schematically shown in FIG. 1.

The feed capillaries to the mixer (1), the residence zone (2), the capillary reactor (3) and the cooler (4) comprised capillary tubes having an internal diameter of 2.25 mm. The residence zone had a length of 10 cm, the capillary reactor a length of 30 cm and the cooler a length of 100 cm. The mixer comprised a screw connection in the shape of a T-piece from Swagelok between feed capillary and residence zone. The unheated plant components mixer (1) and residence zone (2) were in contact with atmospheric air. The capillary reactor was maintained at 235° C. by immersion of (3) in a heated oil bath. The cooler was maintained at 40C by immersion of (4) in a thermostated bath. The capillary reactor and cooler were connected by a capillary having a length of 15 cm and an internal diameter of 2.0 mm.

A 0.2 molar solution of yttrium acetate (YAC₃) as starting material 1 and a 2.0 molar solution of triethanolamine as starting material 2 were made up. Demineralized water (treated using Milli-Qplus, QPAK®2, Millipore Corporation) was used as solvent. The two starting materials were pumped through the plant from starting material containers at room temperature and at a constant flow rate of 5 ml/min in each case by means of high-pressure HPLC pumps provided with pressure sensors (Shimadzu LC-7 A). The pressure in the plant was set to 100 bar at the beginning of the experiment by regulation of the pressure valve (relief valve R3A, Nupro Company). The pressure remained constant during the experiment over a period of 3 hours.

A colloidally stable, slightly opalescent and weakly alkaline (pH=8.6) sol comprising nanosize and spherical particles was obtained as product. Particle size determination by means of electron microscopy indicated amorphous particles having a diameter in the range from 4 to 10 nm. Particle size determination by means of an ultracentrifuge indicated a mean volume average diameter of D₅₀=16 nm.

The particles were isolated by means of centrifugation (Avanti J 30i, Rotor JA 30.50 Ti, Beckman Coulter GmbH) and part of them were predried at 100° C. and subsequently calcined at 800° C. for 1 hour in a furnace. Structure determination by means of X-ray diffractometry (reflection diffractometer DS000, Bruker AXS) of the calcined sample indicated a Y₂O₃ structure or a Y₂O₃-like structure. The uncalcined particles were examined by means of thermogravimetry coupled with mass-spectrometric detection (thermogravimetric balance TGA/SDTA 851e, Mettler-Toledo; quadrupole mass spectrometer Thermostar, Balzers). For this purpose, the particles were isolated by centrifugation and firstly predried at a defined temperature in a stream of inert gas (helium, 50 ml per minute) for a defined time in the TG-MS unit. The sample was then maintained at 100° C. for 1 hour and then heated using a ramp of 5 K per minute to 800° C. Mass spectra were recorded during the entire measurement procedure. The results indicated an yttrium hydroxycarbonate-like structure.

### Example 2

Yttrium-containing nanoplatelets were produced by a method analogous to Example 1.

A 0.2 molar aqueous solution of yttrium chloride (YCl₃) as starting material 1 and a 0.2 molar aqueous solution of triethanolamine as starting material 2 were made up. The capillary reactor was heated to 160° C. and the two starting materials were pumped through the plant at a constant flow rate of 2.5 ml/min in each case. The pressure remained constant during the experiment over a period of 3 hours. After centrifugation of the opalescent product dispersion, the clear supernatant liquid was replaced by demineralized water. The sedimented solid was subsequently redispersed by stirring, giving a slightly opalescent and colloidally stable sol.

Examination of the particle size and morphology by means of electron microscopy indicated platelet-like yttrium hydroxide particles having a diameter in the range from 200 to 500 nm and a thickness of <10 nm.

### Example 3

Yttrium- and europium-containing nanoparticles were produced as precursor of a Y₂O₃:Eu phosphor by a method analogous to Example 1.

A 0.2 molar aqueous solution of yttrium acetate (YAc₃) containing 8 mM of europium acetate as starting material 1 and a 2.0 molar aqueous solution of triethanolamine as starting material 2 were made up. The capillary reactor was heated to 195° C. and the two starting materials were pumped through the plant at a constant flow rate of 5 ml/min in each case. The pressure remained constant during the experiment over a period of 3 hours.

A colloidally stable and slightly turbid sol containing europium-doped yttrium hydroxyacetate nanoparticles was obtained as product. The solids content of this sol was 0.80% by weight (based on oxide in the dried water-free state). The yield of the reaction was at least 71%.

The particles were isolated by means of centrifugation and (after predrying at 100° C.) subsequently calcined at 800° C. for 1 hour in a muffle furnace. The calcined sample displays intensive fluorescence under UV excitation (254 nm), which shows that the particles are europium-doped.

### Example 4

Dysprosium-containing nanoparticles were produced by a method analogous to Example 1.

A 0.2 molar aqueous solution of dysprosium acetate (DyAc₃) as starting material 1 and a 2.0 molar aqueous solution of triethanolamine as starting material 2 were made up. The capillary reactor was heated to 200° C. and the two starting materials were pumped through the plant at a constant flow rate of 10 ml/min in each case.

A colloidally stable and slightly opalescent sol containing nanosize and spherical particles and having a solids content of 1.36% by weight (based on oxide) was obtained as product.

To concentrate the sol, the particles were isolated by means of centrifugation (Avanti J 30i, Rotor JA 30.50 Ti, Beckman Coulter GmbH) and redispersed in demineralized water. A transparent sol containing dysprosium-containing nanoparticles (dysprosium hydroxyacetate) and having a solids content of 12.0% by weight (based on oxide in the dried water-free state) was obtained.

Particle size determination by means of electron microscopy indicated a diameter in the range from 5 to 10 nm. Particle size determination by means of an ultracentrifuge indicated a mean volume average diameter of D₅₀ 16 nm. The yield of the reaction was at least 73%.

### Example 5

Dysprosium-containing nanoparticles were produced by a method analogous to Example 4,

A 0.2 molar aqueous solution of dysprosium acetate (DyAc₃) as starting material 1 and a 2.0 molar aqueous solution of triethanolamine as starting material 2 were made up. The capillary reactor having a length of 15 cm was maintained at 120° C. and a multilamellar mixer (comb mixer, Ehrfeld Mikrotechnik BTS GmbH) was used as mixer. The two starting materials were pumped through the plant at a constant flow rate of 10 ml/min in each case. The pressure remained constant during the experiment over a period of 3 hours.

A transparent nanosol (dysprosium hydroxyacetate nanoparticle) was obtained as product. Particle size determination by means of an ultracentrifuge indicated a mean volume average diameter of D₅₀=5 nm.

### Example 6

Cerium-containing nanoparticles were produced by a method analogous to Example 5.

A 0.2 molar aqueous solution of cerium chloride (CeCl₃) as starting material 1 and a 0.2 molar aqueous solution of triethanolamine as starting material 2 were made up. The capillary reactor was heated to 190° C. and the two starting materials were pumped through the plant at a constant flow rate of 10 ml/min in each case.

A turbid and slightly yellowish dispersion containing nanosize particles was obtained as product. Examination of the particle size and morphology by means of electron microscopy indicated rod-shaped CeO₂ particles having a length in the range from 50 to 200 nm and an aspect ratio in the range from 2 to 3.

### Example 7

Nickel-containing nanoparticles were produced by a method analogous to Example 1.

A 0.2 molar aqueous solution of nickel nitrate (Ni(NO₃)₂) as starting material 1 and a 2.0 molar aqueous solution of triethanolamine as starting material 2 were made up. The capillary reactor was heated to 200° C. and the two starting materials were pumped through the plant at a constant flow rate of 2.5 ml/min in each case.

A turbid, green dispersion was obtained as product. After centrifugation of the product dispersion, the clear supernatant liquid was replaced by demineralized water. The sedimented solid was subsequently redispersed by stirring, giving a green but transparent and colloidally stable sol.

Examination of the particle size and morphology by means of electron microscopy indicated spherical nickel dihydroxide nanoparticles having a diameter in the range from 10 to 15 nm.

### Example 8

Silver-containing nanoparticles were produced by a method analogous to Example 1.

A 0.2 molar aqueous solution of silver nitrate (AgNO₃) as starting material 1 and a 2.0 molar aqueous solution of triethanolamine containing 2% by weight of PVP K15 (Fluka) as starting material 2 were made up. The capillary reactor was heated to 120° C. and the two starting materials were pumped through the plant at a constant flow rate of 10 ml/min in each case.

A greyish black transparent dispersion was obtained as product. After centrifugation of the product dispersion, the clear supernatant liquid was replaced by demineralized water. The sedimented solid was subsequently redispersed by stirring, giving a transparent and colloidally stable sol.

Examination of the particle size and morphology by means of electron microscopy indicated approximately spherical Ag₂O nanoparticles having a broad particle size distribution (diameter in the range from 10 to 60 nm).

### Example 9

Niobium-containing nanoparticles were produced by a method analogous to Example 5.

A 0.2 molar aqueous solution of ammonium niobium oxalate (H.C. Starck GmbH) as starting material 1 and a 2.0 molar aqueous solution of triethanolamine as starting material 2 were made up. The capillary reactor was heated to 160° C. and the two starting materials were pumped through the plant at a constant flow rate of 10 ml/min in each case. The pressure remained constant during the experiment over a period of 6 hours.

A water-clear and slightly alkaline (pH 8.4) sol containing nanosize particles was obtained as product. To isolate and concentrate the particles, 100 parts of this sol were admixed with 40 parts of acetone and left to stand for 24 hours to precipitant the particles. The sediment formed after centrifugation was subsequently taken up in 30 parts of water and redispersed by introduction of ultrasound (Branson Digital Sonifier). The residual content of acetone in this redispersed sol was taken off at 40° C. on a rotary evaporator.

Filtration through a 450 nm filter (Millex HV®, Millipore Corporation) gave a transparent sol containing niobium-containing nanoparticles and having a solids content of 7.5% by weight.

Examination of the particle size and morphology by means of electron microscopy indicated amorphous particles having a diameter in the range from 5 to 15 nm.

The particles were examined by means of ESCA (Electron Spectroscopy for Chemical Analysis, Escalab 2201-XL, Thermo VG Scientific) and EDX (Energy Dispersive X-ray Analysis, Philips CM 20). The measurements indicated an amorphous Nb₂O₅ structure.

### Example 10

Niobium-containing nanoparticles were produced by a method analogous to Example 5.

A 0.2 molar aqueous solution of ammonium niobium oxalate (H.C. Starck GmbH) as starting material 1 and a 1.0 molar aqueous solution of ethanolamine as starting material 2 were made up. The capillary reactor was heated to 180° C. and the two starting materials were pumped through the plant at a constant flow rate of 20 ml/min in each case.

A slightly opalescent and weakly alkaline (pH 8.4) sol containing nanosize particles was obtained as product. To isolate the particles, this sol was dialysed until the pH had dropped to 7.3. The sol is subsequently evaporated on a rotary evaporator.

Examination of the particle size and morphology by means of electron microscopy indicated amorphous particles having a diameter in the range from 5 to 15 nm.

The composition of the particles was determined by means of thermogravimetry. The measurements indicated an Nb₂O₅ hydrate.

### Example 11

Niobium-containing nanoparticles were produced by a method analogous to Example 5.

A 0.2 molar aqueous solution of ammonium niobium oxalate (H.C. Starck GmbH) as starting material 1 and a 1.0 molar aqueous solution of diethanolamine as starting material 2 were made up. The capillary reactor was heated to 200° C. and the two starting materials were pumped through the plant at a constant flow rate of 20 ml/min in each case.

A slightly opalescent and slightly alkaline (pH=8.4) sol containing nanosize particles was obtained as product. To purify the particles, this sol was dialysed until the pH had dropped to 7.5. The sol is subsequently evaporated on a rotary evaporator.

Examination of the particle size and morphology by means of electron microscopy indicated amorphous particles having a diameter in the range from 5 to 15 nm.

The composition of the particles was determined by means of thermogravimetry (MettlerToledo SDTA 851E). The measurements indicated an Nb₂O₅ hydrate.

### Example 12

Tantalum-containing nanoparticles were produced by a method analogous to Example 5.

To produce the starting material 1, an aqueous tantalum oxalate solution (H.C. Starck GmbH) was diluted with water to a tantalum concentration of 0.2 mol/l. A 2.0 molar aqueous solution of triethanolamine was made up as starting material 2. The capillary reactor having a length of 45 cm was maintained at 160° C. The two starting materials were pumped through the plant at a constant flow rate of 10 ml/min in each case. The pressure remained constant during the experiment over a period of 1 hour.

The product from the hydrothermal reactor was purified by dialysis (Visking dialysis tube, type 36/32, Carl Roth GmbH&Co) against demineralized water. A transparent and colloid-chemically stable sol containing Ta₂O₅ nanoparticles and having a solids content of 1.56% by weight (based on oxide in the dried water-free state) and a pH of 7.5 was obtained.

Examination of the particle size by means of dynamic light scattering indicated particles having an effective hydrodynamic diameter of 78 nm (intensity average) or 21 nm (number average).

The yield of the reaction was at least 76%.

### Comparative Example

Comparative example in accordance with U.S. Pat. No. 5,652,192 A and WO 94/01361 A.

An aqueous solution containing 0.1 mol/l of yttrium chloride (YCl₃) and 1.0 mol/l of urea was made up as starting solution. As reaction plant, the plant of Example 1 was modified for operation using only one starting solution, i.e. by removal of component 1 (the mixer). The capillary reactor was heated to 235° C. and the starting solution was pumped through the plant at a constant flow rate of 10 ml/min. The pressure in the plant was set to 100 bar at the beginning of the experiment by regulation of the pressure valve.

During the experiment over a period of 20 minutes, the pressure rose steadily to a pressure of 300 bar and more, as a result of which the experiment had to be stopped.

A colloidally unstable and turbid dispersion having a pH of 6.5 and a solids content of 10.0 g/l (after drying at 120° C.) was obtained as product. During storage overnight, the dispersion clarified by partial dissolution of the precipitated particles.

The yield of the reaction was not more than 40%.

1-13. (canceled)

14. A process for producing microparticles or nanoparticles of rare earth metal compounds or other transition metal compounds which comprises homogeneous precipitating the microparticles or nanoparticles of rare earth metal compounds or other transition metal compounds from a metal salt solution of at least one of the corresponding rare earth metals or transition metals by means of one or more precipitation reagents, wherein one or more weakly basic compound(s) which are soluble in a solvent or solvent mixture and are stable at the process temperature are used as precipitation reagent and the precipitation is carried out under hydrothermal conditions.

15. The process according to claim 14, wherein the precipitation reagent is a primary, secondary or tertiary amine, an amino alcohol or a mixture of these.

16. The process according to claim 14 wherein
metal salts and precipitation reagents are firstly mixed with one another in the solvent or solvent mixture to produce a homogeneous precipitation mixture (mixing phase),
the temperature of the precipitation mixture is subsequently increased (precipitation phase) and
after the precipitation is complete, the microparticles or nanoparticles obtained are discharged, optionally after cooling.

17. The process according to claim 14, wherein the homogeneous precipitation mixture is produced by mixing at least two starting solutions, with one of the starting solutions being a metal salt solution of at least one of the corresponding rare earth metals or transition metals and a further starting solution containing one or more precipitation reagents.

18. The process according to claim 16, wherein the homogeneous precipitation mixture is produced by mixing at least two starting solutions, with one of the starting solutions being a metal salt solution of at least one of the corresponding rare earth metals or transition metals and a further starting solution containing one or more precipitation reagents.

19. The process according to claim 14, wherein the duration of the mixing phase is set so that the formation of metal salt nuclei before commencement of the precipitation phase is minimized.

20. The process according to claim 18, wherein the duration of the mixing phase is set so that the formation of metal salt nuclei before commencement of the precipitation phase is minimized.

21. The process according to claim 16, wherein the process is operated continuously.

22. The process according to claim 21, wherein the continuous process is operated in a capillary system comprising one or more micromixers, residence zone, reactors, cooler and pressure valves.

23. The process according to claim 20, wherein the process is operated continuously.

24. The process according to claim 23, wherein the continuous process is operated in a capillary system comprising one or more micromixers, residence zone, reactors, cooler and pressure valves.

25. The process according to claim 22, wherein, in continuous operation in the capillary reactor, the duration of the mixing phase plus the duration of the precipitation phase is less than 5 minutes.

26. The process according to claim 24, wherein, in continuous operation in the capillary reactor, the duration of the mixing phase plus the duration of the precipitation phase is less than 5 minutes.

27. The process according to claim 14, wherein the microparticles or nanoparticles are obtained in the form of a sol, a paste or a non-Newtonian liquid.

28. The process according to claim 26, wherein the microparticles or nanoparticles are obtained in the form of a colloidally stable sol, a paste or a non-Newtonian liquid.

29. The process according to claim 14, wherein the microparticles or nanoparticles are obtained in the form of a sol having a pH of from 7 to 12.

30. The process according to claim 28, wherein the microparticles or nanoparticles are obtained in the form of a sol having a pH of from 7 to 10.

31. The process according to claim 14 for producing inorganic microparticles or nanoparticles coated with rare earth metal compounds or other transition metal compounds by homogeneous precipitation from a metal salt solution of at least one of the corresponding rare earth metals or transition metals by means of one or more precipitation reagent(s), characterized in that coating is effected from a homogenized precipitation mixture which comprises two or more starting solutions, with one of the starting solutions being a metal salt solution and the second starting solution containing inorganic microparticles or nanoparticles, and to which the precipitant is added either together with one of the two starting solutions or with a further starting solution.

32. Nanoparticles or microparticles containing niobium or tantalum compounds, which are obtained by a process according to claim 14.

33. Sols containing the nanoparticles or microparticles according to claim 32.
